(19) United States
(12) Patent Application Publication
(10) Pub. No.: US 2025/0050181 A1
(43) Pub. Date: Feb. 13, 2025

(54) Part constitutive of a gripping set and gripping set

(71) Applicant: GESTION INVERGARA SLU, Terrassa (ES)

(72) Inventor: Francisco FRANCISCO GARCIA BEJAR, Terrassa (ES)

(21) Appl. No.: 18/721,697

(22) PCT Filed: Dec. 20, 2022
(86) PCT No.: PCT/ES2022/070827

§ 371 Date: Jun. 19, 2024

(30) Foreign Application Priority Data
Dec. 21, 2021 (ES) P202131187

(51) Int. Cl. A63B 60/14

(52) U.S. Cl. CPC A63B 60/14

(57) ABSTRACT

Part (1′) constitutive of a gripping set for a handle (M) of sporting equipment, the part comprising (1′) an annular elastic band (11′) diametrically dimensioned to fit tightly onto the peripheral surface of the handle (M), and at least one projection (12′) joined to the annular elastic band (11′), the length (1′L) of the part (1′) in the axial direction of the annular elastic band (11′) being at most 25 mm and wherein at least one edge of the annular elastic band (11′) comprises one or more axial notches (11′R) whose maximum perimeter arc (11′A) is between 8 mm and 25 cm.

The object of the present invention application is to register a part constitutive of a set for the improvement of gripping of sports elements that have handles. Another object of the application is said gripping set, which comprises a plurality of said parts, which can be installed in an easy, quick and adjustable way, in addition to being manufactured very economically. Its field of application falls within the sector of sports elements, specifically in that of components for the improvement of gripping of the handles of rackets, paddle tennis rackets, golf or hockey clubs and the like.

### STATE OF THE ART

In sports such as golf, field or ice hockey, tennis or paddle tennis, players use a hitting element (called, for example, club, stick, racket or paddle depending on the sport) that is gripped by its handle. Since the game occurs quickly, a player does not always have time to stop and put his hands in the proper handle gripping positions. On the other hand, due to the player's sweating, the surface of the handle becomes more slippery, with the risk of the hitting element slipping.

The handles of these hitting elements are practically always covered with an adhesive tape (known as grip) that is somewhat absorbent and padded, which improves the gripping, but the player must still squeeze the hand firmly to ensure that it does not slip. Additionally, they lack indicators that guide the player in hand placement.

With the intention of solving the above drawbacks, handle coatings are known in the state of the art, both in tubular and roll-up laminar form, which have housings on their surface sized to accommodate the fingers and/or phalanges of the player (such as the one disclosed in document ES1256105U). These areas, even after being covered with an adhesive tape, demarcate deepened gaps that are easily noticeable by the player when contacting the handle, providing a real improvement in the indication of the hand position and in gripping. However, being a single part, the structure does not allow adjustment of the size and position of the accommodations, so it is not possible to customize it to the different hand sizes that players have. Therefore, in most cases, a player's fingers and phalanges do not fit into the corresponding spaces, which generates some discomfort. This drawback extends to many other single-part handles (such as that disclosed in document CN112473101A) and to parts intended to be joined (such as those disclosed in document U.S. Pat. No. 5,577,722).

On the other hand, different annular parts with projections on the surface are known to improve gripping and positioning of the hand. For example, document U.S. Pat. No. 2,091,458A discloses elastic bands for baseball bats, which have an axially transverse projection arranged as a positioning and fastening element, while also having small pointed teeth distributed over the entire surface to make it non-slip. They also have deep holes on their internal surface, but they are designed to generate suction against the handle and attach to it, not to accommodate the fingers. These parts are not designed to be covered with a grip, since the dimensions of the projection make it unsuitable for this, while the small teeth would remain imperceptible. At the same time, the width of the band is too large to constitute a set of more than one band that is comfortable to hold for any hand size. The same drawback occurs with the projections disclosed in document U.S. Pat. No. 4,072,311A and many other similar ones. For its part, document U.S. Pat. No. 5,335,919A discloses a band for rackets with a transverse perimeter projection that surrounds the entire part, as a positioning and fastening element. It is not intended to form a set of more than one band or to be covered with a grip, since the width of the band or the projection measurements are not indicated. In addition, the projections of the set, by surrounding the entire handle, would also occupy the face of this where the palm of the hand is usually supported (the handles are defined by four main faces; the palm is usually supported on one, the phalanges on another and fingers on the remaining two). Due to this, the user would perceive some discomfort in the palm.

The existence of a part that is part of a set that provides means of positioning the player's fingers and/or phalanges, that are easily covered by a grip, that does not interfere with the palm of the hand and that, at the same time, are adjustable in position, is unknown.

### DESCRIPTION OF THE INVENTION

A first object of the present invention is a part to form a gripping set for rackets and sports elements that have a handle.

The part claimed here comprises at least one projection joined to an annular elastic band diametrically dimensioned to fit tightly onto the peripheral surface of the handle (it is understood that the diameter of the annular elastic band depends on the material used, although between 2 and 3 cm is recommended in its resting condition, i.e., not placed on the handle).

The part is characterized in that its length in the axial direction of the annular elastic band is a maximum of 25 mm. Thanks to this, it is possible to create a set of more than one part that is comfortable for most hand sizes. Otherwise, a lot of players would need to spread their fingers far apart to grip a handle with such a set, which would be annoying and could cause long-term injuries. To make it even more comfortable for any existing hand size, preferably, said length is equal to or less than 20 mm.

The present part is a constituent part of a gripping set that comprises several of said parts, whose position is adjustable to the size of the fingers and phalanges of any user before placing a grip on top of them. Once the handle and the parts are covered with the grip, the user feels a great solidity of gripping without having to clench the fist tightly. From the beginning, the user perceives the security provided and stops having the feeling that the handle may slip, thus relaxing the hand.

Optionally, so that the set of parts can be better distributed on a handle, the part (or specifically the annular elastic band) can have a variable axial length along its perimeter. For example, the arc portion of the annular elastic band where a projection is located may have a longer axial length, while the remaining arc of the annular elastic band may have a shorter axial length. In this way, by placing parts rotated axially by 90 degrees with respect to their adjacent ones, it is possible to place more parts on the same handle.

In relation to the axial length of the annular elastic band, in at least one perimeter section, it is preferably greater than its radial thickness. In fact, the radial thickness of most of the annular elastic band is preferably very thin, so as not to add unnecessary thickness to the handle. On the other hand, part of the annular elastic band may have an axial length less than its thickness. That is, the thickness can be of a sufficiently differentiable magnitude to generate a distinguishable projection after placing the grip, so that it helps the projections to improve gripping. Preferably, the annular elastic band comprises two symmetrical sections with an axial length shorter than the rest of the sections of the annular elastic band. In the event that the annular elastic band includes a projection between the two symmetrical sections, said sections will be intended to house a phalanx and the final part of a player's finger, while the projection will be intended to be held between the knuckles of two fingers.

Optionally, at least one edge of the annular elastic band may comprise one or more axial notches whose maximum perimeter arc is between 8 mm and 25 mm (that is, with a width that covers the measurements of a finger or a phalanx of a adult, depending on hand size). Seen from the peripheral surface of the part, the notch(es) has/have the shape of a sector (either circular or polyhedral), so that, in combination with the axial notch of another part corradial to it, they form a longitudinally adjustable space to house the tip of a finger or a phalanx. With this, the user can reposition the different parts with an adequate separation so that their fingers and/or phalanges can fit in the spaces formed by each pair of parts before covering them with a grip. In some embodiments of the parts, the axial notches may coincide or be considered equivalent to said perimeter sections of the part whose axial length is shorter than the rest of the perimeter sections, but there are also embodiments in which these elements may not coincide or be interpreted in a non-equivalent way.

In relation to the projection or projections of the part, its thickness is preferably greater than 1 mm, so that it can be perceived after being covered with a grip, and, at the same time, less than 10 mm, so that it can be correctly covered by the grip. It is understood that the thickness of a projection is the dimension defined in the radial direction of the annular elastic band. Preferably, the thickness of the at least one projection is less than 5 mm. Additionally, the axial dimension of the apex of at least one projection (i.e., its dimension parallel to the axial axis of the annular elastic band) is preferably less than 5 mm and/or the perimeter dimension (i.e., the dimension perpendicular to the axial dimension) is greater than 3 mm. This makes it easier for the projection to be easily covered with the grip, while generating enough bulge as a lock so that the user can retain the handle without applying great pressure with the hand. On the other hand, the perimeter dimension is preferably greater than the axial dimension, so that the projection defines a rectilinear ledge such that the contact surface of the fingers with the projection is greater.

On the other hand, in any embodiment in which the part comprises more than one projection, preferably, its central axes are rotated with respect to the axial axis of the part by at least 45° and, more preferably, 90°.

In a possible embodiment, the part is immovably attached to at least one projection and, even more preferably, the part and at least part of at least one projection are fused, that is, they form a single body of the same material. In this case, at least one projection may consist of or comprise a body of rigid material fixed to the surface of the annular elastic band, either externally or internally (as an internal core), so as to give it greater rigidity and there is less crushing when tightening it with the grip.

In another possible embodiment, at least one projection is adjacent to one of the edges of the annular elastic band, whether the axial length of the part is close to 25 mm or much less. For example, the set can comprise four parts to be placed on a handle, which is enough to generate four deep gaps in which to house the phalanges and/or fingers (except the thumb, which is usually mounted on top of the index finger when gripping a handle). However, in an embodiment in which the length is equal to or less than 20 mm (preferably even less than 10 mm), the parts can be arranged in pairs symmetrically between them, with their respective projections remaining together and also generating gaps between pairs of parts in order to house the fingers and/or phalanges. In the latter case, the set can comprise six parts or more, taking into account that the shorter its axial length, the more economical its manufacturing is.

A second object of the present invention is a gripping set comprising a plurality of parts (at least two) of any of those described above.

### BRIEF DESCRIPTION OF THE FIGURES

FIG. 1 is a perspective view of a first exemplary embodiment of the constituent part of a gripping set object of the invention.

FIG. 2 is a perspective view of a second exemplary embodiment of the part.

FIG. 3 is a side view of the second exemplary embodiment of the part.

FIG. 4 is an elevation view of both the first and second exemplary embodiments of the part.

FIG. 5 is a perspective view of a gripping set formed by seven parts of the second exemplary embodiment, placed on a paddle tennis racket handle.

FIG. 6 is a bottom perspective view of the second exemplary embodiment of the part.

### DESCRIPTION OF PREFERRED EMBODIMENTS

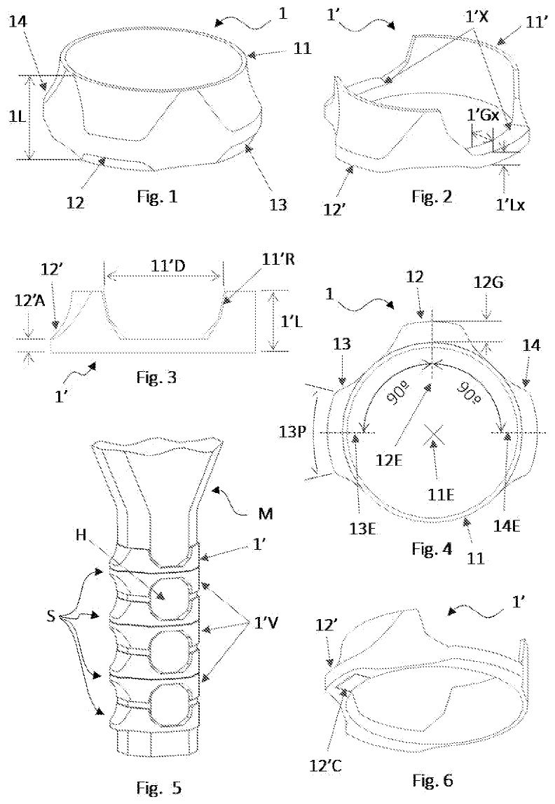

In the first exemplary embodiment, shown in FIG. 1, a part (1) constituting a gripping set for a handle (M) can be seen, which comprises an annular elastic band (11) with a diameter of around 20 mm, that is, suitable for fitting tightly onto the peripheral surface of the handle (M), and of a length (1L) in the axial direction of the annular elastic band (11) of around 10 mm. In this case, the part (1) comprises three projections (12, 13, 14) of the same material as the annular elastic band (11), that is, forming a single fused body.

In the second exemplary embodiment, as seen in FIGS. 2 and 3, the axial length (1′L) of the part (1′) is variable along its perimeter. Specifically, two of its perimeter sections (1′X) are symmetrical to each other and have an axial length (1′Lx) less than the rest of the perimeter sections, as well as less than its own radial thickness (1′Gx).

Seen from the side of the part (1′), as can be seen in FIG. 3, the annular elastic band (11′) comprises two symmetrical axial notches (11′R) on the upper edge, whose maximum perimeter arc (11D) is about 12 mm. In this second embodiment of the part (1′), the axial notches (11′R) can coincide or be considered equivalent to said perimeter sections (1′X) whose axial length (1′Lx) is less than the rest of the perimeter sections, but there are also embodiments (not shown here) in which they may not coincide or be interpreted in a non-equivalent way.

In this FIG. 3 you can also see the axial dimension (12′A) of the apex of the projections (12′, 13′, 14′), which, in this case, is around 2 mm.

FIG. 4 shows an elevation view of the first embodiment of the part (1), although it may also correspond to that of the second embodiment. It shows the thickness (12G) of a first projection (12), which, in this case, is around 3.5 mm, as well as that of the other two projections (13, 14), which is around 2.5 mm. Also appreciated is the perimeter dimension (13P) of the apex of the three projections (12, 13, 14), which, in this case, is greater than 4 mm. It can also be seen that the central axes (12E, 13E, 14E) of the projections (12, 13, 14), shown with dotted lines in the figure, are rotated 90° with respect to the axial axis (11E) of the annular elastic band (11) (this last axial axis (11E) is shown with a cross).

In both shown embodiments of the part (1, 1′), the projections (12, 12′) are adjacent to the lower edge of the annular elastic band (1, 1′). In fact, in the second embodiment of the part (1′), the projection (12′) coincides with the lower edge of the annular elastic band (11′). In turn, as seen in FIG. 6, the projection (12′) comprises a body of rigid material (12′C), in this case as a core, which provides greater rigidity when pressed with a grip.

For its part, FIG. 5 shows a gripping set formed by seven parts (1′) of the second exemplary embodiment placed on a handle (M) of a racket or paddle tennis racket, three of the parts (1′V) being turned, which together with those that are not turned form projections (S) and/or deepened gaps (H) on each of the three faces of the handle (M) in which the user's fingers or phalanges are housed.

1. Part constitutive of a gripping set for a handle of sporting equipment, the part comprising an annular elastic band diametrically dimensioned to fit tightly onto the peripheral surface of the handle, and at least one projection joined to the annular elastic band, wherein the length in the axial direction of the annular elastic band is a maximum of 25 mm.

2. Part constitutive of a gripping set according to claim 1, wherein said length is a maximum of 20 mm.

3. Part constitutive of a gripping set according to claim 1, wherein said length is variable along its perimeter.

4. Part constitutive of a gripping set according to claim 1, wherein at least one perimeter section has an axial length greater than its radial thickness.

5. Part constitutive of a gripping set according to claim 1, wherein at least one perimeter section has an axial length less than its radial thickness.

6. Part constitutive of a gripping set according to claim 1, wherein two of its perimeter sections are symmetrical to each other and have an axial length smaller than the rest of the perimeter sections.

7. Part constitutive of a gripping set according to claim 1, wherein at least one edge of the annular elastic band comprises one or more axial notches whose maximum perimeter arc is between 8 mm and 25 cm

8. Part constitutive of a gripping set according to claim 1, wherein the thickness of at least one projection is greater than 1 mm and less than 10 mm.

9. Part constitutive of a gripping set according to claim 8, wherein the thickness of the at least one projection is less than 5 mm.

10. Part constitutive of a gripping set according to claim 1, wherein the axial dimension of the apex of at least one projection is less than 5 mm.

11. Part constitutive of a gripping set according to claim 10, wherein the perimeter dimension of the apex of at least one projection is greater than 3 mm.

12. Part constitutive of a gripping set according to claim 1, wherein it comprises two or more projections whose central axes are placed rotated with respect to the axial axis of the annular elastic band by at least 45°.

13. Part constitutive of a gripping set according to claim 12, wherein said central axes are rotated by 90°.

14. Part constitutive of a gripping set according to claim 1, wherein at least one projection is joined to the annular elastic band immovably.

15. Part constitutive of a gripping set according to claim 14, wherein the annular elastic band and at least part of one projection form a single body of the same material.

16. Part constitutive of a gripping set according to claim 15, wherein at least one projection comprises a body of rigid material.

17. Part constitutive of a gripping set according to claim 1, wherein at least one projection is adjacent to one of the edges of the annular elastic band.

18. Gripping set for a handle of sporting equipment, wherein it comprises at least two parts comprising an annular elastic band diametrically dimensioned to fit tightly onto the peripheral surface of the handle, and at least one projection joined to the annular elastic band, wherein the length in the axial direction of the annular elastic band is a maximum of 25 mm.
